(19) United States
(12) Patent Application Publication
(10) Pub. No.: US 2008/0202016 A1
(43) Pub. Date: Aug. 28, 2008

(54) Dragonfly fishing lure

(76) Inventor: John W. Robertson, Sparta, WI (US)

Correspondence Address: Intellectual Property Dept.;Dewitt Ross & Stevens SC, 2 East Mifflin Street, Suite 600, Madison, WI, 53703-2865, US

(21) Appl. No.: 11/713,901

(22) Filed: Feb. 27, 2007

(51) Int. Cl. A01K 85/00

(52) U.S. Cl. 43/42.27; 43/42.35; 43/42.45

(57) ABSTRACT

A realistically shaped dragonfly fishing lure with a body comprised of several sections, which mimic those of a dragonfly. The dragonfly fishing lure has an H-shaped wing positioned on the top side of the body. More specifically, the H-shaped wing is attached to the thorax of the dragonfly fishing lure. The dragonfly fishing lure has at least one hook attached to the bottom of the body. The dragonfly fishing lure is designed to realistically look like and behave like a real dragonfly, thus replacing prior dragonfly lures.

### FIELD OF THE INVENTION

This invention relates to fishing lures, and more particularly to lures that mimic the action and appearance of live insects. This invention looks like a dragonfly and when cast across water, the invention mimics the behavior of a live dragonfly.

### DESCRIPTION OF THE PRIOR ART

People have long participated in catching fish for both sustenance and enjoyment. For whatever reason a person attempts to catch fish, the goal is the same. The more fish a person can catch, the more rewarding the experience. Thus, the challenge has always been to design a better lure to attract and hook fish.

Most effective lures are roughly designed to resemble the natural prey of fish. Different species of fish have preferential food sources based on the fish's biology and its natural habitat. For example, a fresh-water catfish from the family Ictaluridae generally feeds from the bottom of its water habitat and this behavior is facilitated because of the subterminal orientation of the fish's mouth. A fresh-water bass from the family Percichthydae has a more upturned mouth and will often feed on insects above the water line. So an artificial fishing lure that resembles a flying insect will likely attract a bass rather than a catfish.

Fishing enthusiasts often seek fishing lures that are most attractive to certain types of fish. The desire for the best lure often encourages creation and innovation of new lures. U.S. Pat. No. 3,871,112 to Jacobs discloses a lure that attempts to imitate the body structure of a dragonfly, an insect of choice for fish similar to bass. Jacobs presents a simple design for the body of a dragonfly comprising a head, a rear section and two wings. Although the Jacobs lure has some semblance of a dragonfly, there are several faults with the design. While the head of the lure is accurate, the rear section is too thick and fails to mimic the actual shape of the body of a real dragonfly. Furthermore, the wings on the Jacobs lure are flat strips made of flexible rubber which are designed to agitate the water similar to a distressed dragonfly. The Jacobs lure does not replicate a dragonfly in any other situation.

U.S. Pat. No. 5,133,148 to Lawson discloses a complex approach for simulating a dragonfly. Lawson describes a lure that is more similar to an airplane than a dragonfly. The lure comprises a drive motor connected to a propeller that will fly and hover over a body of water, while remotely attached to a fishing rod or other stabilized control device. Furthermore, the wing structure claimed by Lawson is implicit to attain enough drag for the lure to remain aloft. The wings of a natural dragonfly are significantly different in visible design and function.

Another innovation by a creative angler is U.S. Pat. Nos. 6,237,276 and 6,955,005 to Storelli. The devices are similar, and both are designed to replicate a variable type of insect hovering above the water surface. The major part of these lures is a buoyant float to which additional pieces are attached. The float may resemble any generic plant or floating detritus that may float on top of a body of water, such as a lily pad or log. An additional fish lure is loosely attached to the float in such a way that the lure dangles above the water. The fishing line, secured to the lure, is threaded through an aperture on the float. The design of the Storelli device prevents a barbed lure from becoming entangled in weeds or other debris by preventing the lure from entering the water. Although Storelli provides an innovative mechanism for catching fish and suggests that a dragonfly may be used, the improvement in the realism of a dragonfly lure is not addressed.

While each of these lures and accessories are novel and useful, a need still exists to improve the realism of certain lures.

### SUMMARY OF THE INVENTION

The present invention addresses the need for a fishing lure that realistically looks and acts like a natural dragonfly. The present invention is a fishing lure with a body having the shape resembling a dragonfly from the order Odonata and infraorder Anisoptera.

The fishing lure is comprised of a body, an H-shaped wing structure, and an eyelet. The body has a longitudinal axis extending from a first end to a second end, wherein the body includes a dorsal side and a ventral side. The H-shaped wing structure includes a crossbar and two sets of generally parallel extensions. Each set of extensions includes a distal end and proximal end. The proximal ends combine at the crossbar, which is positioned over, and removably attached to, the dorsal side of the body. The distal end of each set of extensions extends outwardly from the crossbar and perpendicularly to the longitudinal axis of the body. A space is defined between each set of extensions; The lure has an eyelet positioned on the first end of the body. The eyelet has an appropriate aperture for receiving a fishing line.

The present invention is further directed to a fishing lure comprising a body, a bi-wing H-shaped wing, and an eyelet. The body has a longitudinal axis extending from a first end to a second end, wherein the longitudinal axis includes a dorsal side and a ventral side. The bi-wing H-shaped wing structure includes a first and a second wing structure positioned in alignment with respect to each other. Each of the first and second wing structures includes a crossbar and two sets of generally parallel extensions. Each set of extensions includes a distal end and proximal end. The proximal ends combine at the crossbar. The crossbar of the first wing structure is positioned over, and removably attached to, the dorsal side of the body. The crossbar of the second wing structure is positioned in direct alignment over the crossbar of the first wing structure and is also removably attached to the dorsal side of the body. A spacer is provided between the crossbars of the first and second wing structure such that an air space is defined between the first and second wing structures.

The present invention has many advantages over prior fishing lures. The body of the present invention more realistically looks like a natural dragonfly because the body is partitioned to include a head, a thorax, the petiole, and an abdomen. Prior dragonfly lures did not articulate the body in such a fashion. The inclusion of the petiole to the present invention distinctly adds to the realism of the dragonfly.

The distinctive design of the wings on the present invention allows it to more realistically behave like a real dragonfly. The lure is attached to the fishing rod by the eyelet on the head of the lure. When an angler casts from an underhand position, beginning around three o'clock and gently moving up and across the body, finally releasing around eleven o'clock, the lure glides through the air like a dragonfly. The shape and position of the H-shaped wing helps the lure orient itself and glide through the air. The in-flight orientation helps the dragonfly lure to land in the water with the hooks down and the wings up. The lure will float on the water with the hooks below the surface. An angler can reel in the lure gently or quickly with jerking movements. When reeled in gently the lure behaves like a dragonfly slowly skimming across the water. When the angler reels the lure in more quickly, the lure behaves like a dragonfly periodically lighting off the water. The behavior of the present invention more realistically mimics the behavior of real dragonflies.

The unique design of the present invention gives anglers a significant tool in their tackle box. The accurately shaped body and the shape and performance of the wings encourage hungry fish to attack.

The objects and advantages of the invention will appear more fully in the following detailed description of the preferred embodiment of the invention made in conjunction with the accompanying drawings.

### BRIEF DESCRIPTION OF THE DRAWINGS

FIG. 1 is a front perspective view of the dragonfly lure with a single wing and two trident hooks.

FIG. 2 is a top plan view of the dragonfly lure of FIG. 1.

FIG. 3 is a side view of the dragonfly lure of FIG. 1.

FIG. 4 is a front view of the dragonfly lure of FIG. 1.

FIG. 5 is a side view of the dragonfly lure with a bi-wing and two trident hooks.

FIG. 6 is a top perspective view of the dragonfly lure of FIG. 5.

FIG. 7 is a side view of the dragonfly lure with a single wing, two fixed position hooks, and a weed guard.

### DETAILED DESCRIPTION

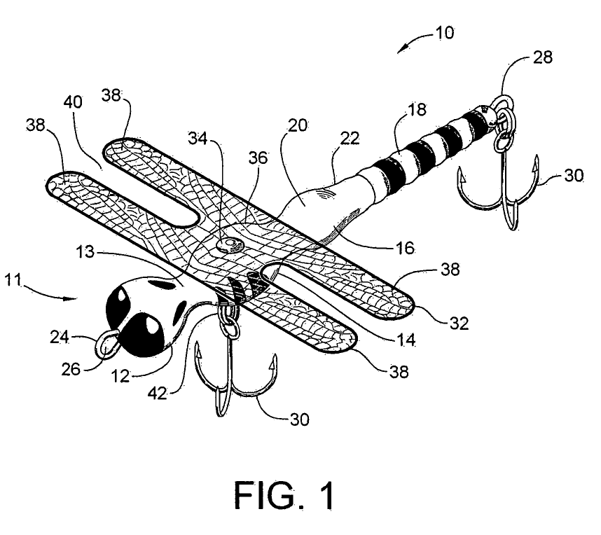

FIG. 1 is an illustrated view of the present invention. The dragonfly lure 10 is generally comprised of a body 11, a wing 32, and a variable number of hooks 30. The body 11 of the dragonfly lure 10 is designed to realistically mimic the body structure of a dragonfly from the order Odonata and the infraorder Anisoptera. These realistic structures of the body 11 include first a head 12, then a thorax 14, next a petiole 16, and lastly an abdomen 18. The head 12 of the body 11 is a bulbous structure. The head 12 and thorax 14 are separated by an annular groove 13. The thorax 14 is also a bulbous structure. The petiole 16 is separated from the thorax 14 by another annular groove 15. The petiole 16 is also a bulbous structure with a slightly smaller diameter than the head 12 and thorax 14. The petiole gradually forms into an extended abdomen 18. The body 11 of the dragonfly lure can be constructed of any floatable material such as wood, plastic, rubber, or any other material that floats on top of the water. The body 11 can be either hollow or solid.

A wing structure 32 is attached to the top of the body 20. The wing 32 is comprised of a crossbar 36 and four extensions 38. The overall appearance of the wing 32 is an H-shape. The crossbar 36 is fixed via an attachment means 34 to the top of the thorax 14. The attachment means 34 pierces through the center of the crossbar 36 and into a central portion of the thorax 14. The attachment means 34 is preferably a fixed means such as a rivet or a nail. However, the attachment means 34 may also be a removable structure, such as a screw or other dowel rod placed into the thorax, so that the wing may be removed for storage or replacement. Extensions 38 extend laterally outward from the crossbar 36 of the wing 32. The extensions 38 extend perpendicular to the axis of the body 11. The wing 32 has two generally parallel extensions 38 extending on either side of the body 11, thus making a total of four extensions 38. The extensions 38 define a fixed space 40 between each set of extensions 38. The space 40 extends from the tip of the extensions inwardly to the crossbar 36 of the wing 32. Without wishing to be held to one particular explanation for the success of the device, the H-shaped wing structure, which encompasses the four separate, flexible extensions 38 in combination with the defined fixed spaces 40, provides the unique aerodynamic quality required to mimic the dragonfly flight pattern as the lure 10 is cast by an angler.

The wing 32 is a single piece of material. The wing 32 is preferably constructed of a thin, flexible and lightweight film. However, the wing 32 may also be made of other lightweight and flexible materials such as balsa wood, aluminum, or other plastics, etc. The wings can be made of material that is either translucent or opaque.

It is also within the scope of the present invention to remove the wing structure 32 entirely thereby leaving a lure similar to a standard fishing plug. In this manner, the lure can be cast and retrieved in the manner of standard plugs.

The dragonfly lure 10 also has several eyelets along the body 11. An eyelet 24 is positioned on the head 12 of the body 11. This eyelet 24 includes an aperture 26 through which a fishing line (not illustrated) is secured. Preferably this eyelet is fixed; however, it can also be constructed to rotate or swivel. The dragonfly lure 10 in FIG. 1 also has two eyelets to secure hooks. In the preferred example, a lower eyelet 42 is positioned along the bottom 22 of the body. Specifically the lower eyelet 42 is secured to the thorax 14 directly beneath the attachment 34 of the wing 32. A trident hook 30 is attached to the lower eyelet 42. FIG. 1 shows a fixed lower eyelet 42; however, it may be constructed so that it is a swiveling eyelet. Furthermore, the lower eyelet 42 may be positioned anywhere along the bottom 22 of the body. In another embodiment of the dragonfly lure, there can be multiple lower eyelets 42 and trident hooks 30 positioned along the bottom 22 of the body. As illustrated in FIG. 1, the present invention 10 also has a tail eyelet 28. This eyelet remains fixed and connects to a trident hook 30. However, the tail eyelet 28 may also swivel or rotate. Although trident hooks are described herein and illustrated in the figures, it is within the scope of the invention to have any number of sizes and shapes of hooks, including single hooks, double hooks, quadruple hooks, etc.

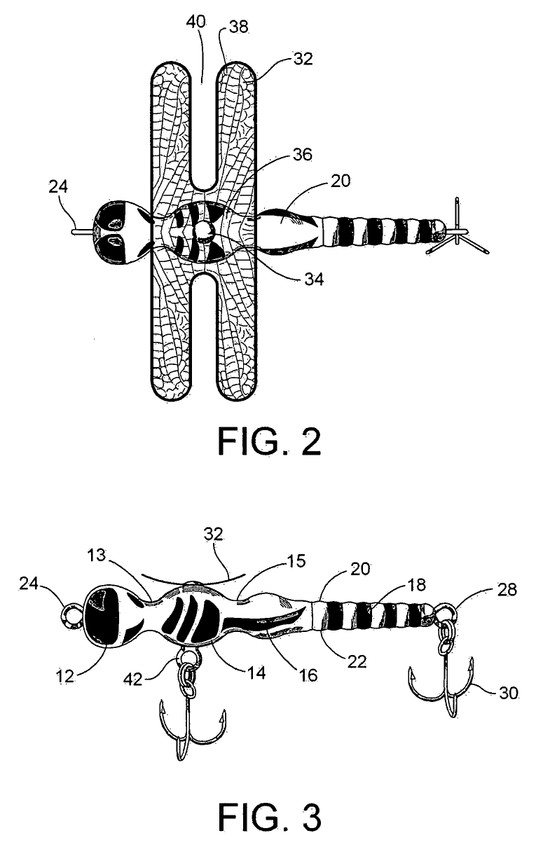

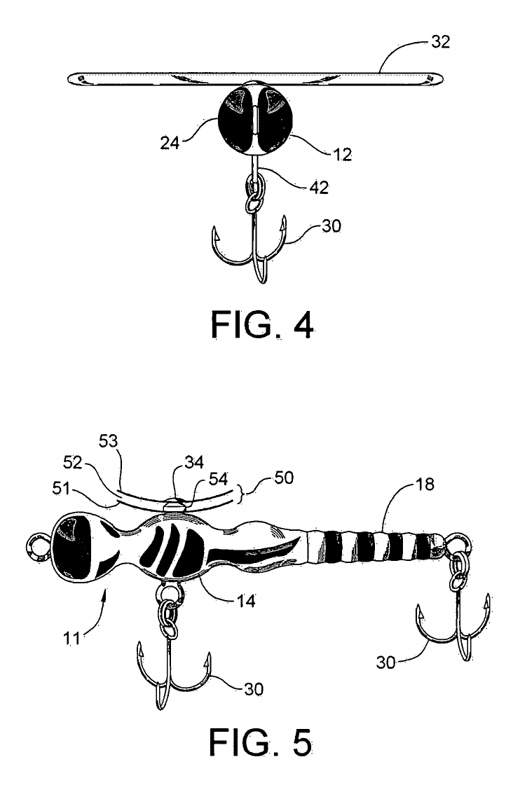

FIG. 2 illustrates a top plan view of the dragonfly lure 10. The space 40 defined between the wing extensions 38 is visible. FIG. 3 represents a side view of the dragonfly lure 10. The wings 32 in FIG. 3 show a slight curvature. However, it is in the scope of the present invention for the wings 32 to be flat or curved at a greater degree. Representative painting or coloration of the body is visible in FIG. 3. FIG. 4 is a front view of the dragonfly lure 10. The dragonfly lure 10 can also be a solid color or painted any variation similar to a natural or fanciful dragonfly. While it may be desirable to color the body 11 in such a way that it resembles a real dragonfly, the color of the dragonfly lure is secondary in importance to the shape of the body and of the wings.

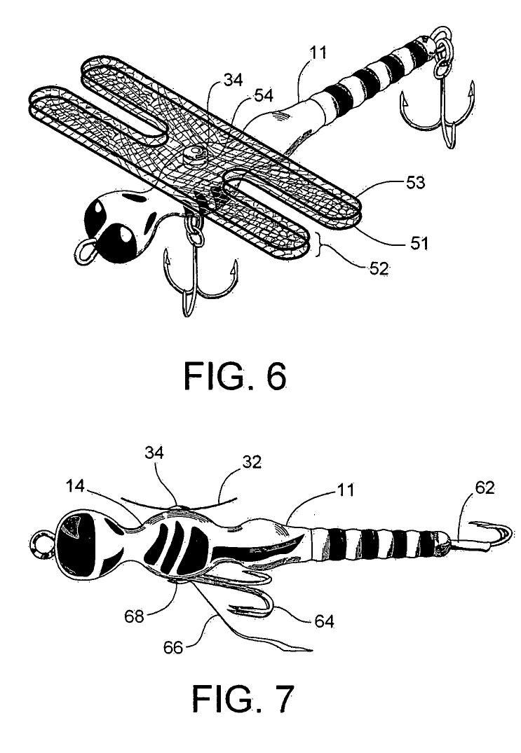

In another embodiment, the dragonfly lure 10 has a bi-wing 50 as illustrated in FIG. 5. The body 11 of the dragonfly lure 10 remains constant; however, it has two stacked wings 51, 53. The bi-wing 50 is constructed of a first wing 51 that is attached to the top of the body, preferably at the thorax 14. A second wing structure 53 is thus positioned directly on top of the first wing 51. Between the two wings 51, 53 is a spacer 54 that separates the wings 51, 53. The spacer 54 is preferably only a couple millimeters in thickness, however, the spacer 54 could be any thickness. A space 52 is thus defined between the two wing structures 51, 53 of the bi-wing 50. The space 52 is generally the same thickness as the spacer 54. The preferred configuration of the bi-wing 50 is comprised of two wings 51, 53 of the same size and same shape. However, it may be appropriate to have two different sized wings of different shapes and curvatures. Furthermore, the bi-wing 50 can be placed along different parts of the body 11, including the thorax and petiole, or even the abdomen. FIG. 5 illustrates a body 11 with two trident hooks 30, one attached under the thorax 14 and the other at the end of the abdomen 18. However, additional or fewer hooks may be used. FIG. 6 is a perspective view of the bi-wing 52 construction. The space 52 between the two wings 51, 53 is visible.

In yet a further embodiment of the dragonfly lure, a weed guard 66 is attached to the body 11. The weed guard 66 is made of a thin and lightweight metal. However, the weed guard 66 can be constructed of any flexibly rigid material. FIG. 7 shows a single wing 32 attached to the thorax 14 of the body 11. Instead of dangling trident hooks 30, a fixed lower hook 64 is positioned on the bottom of the thorax 14. The fixed lower hook 64 is attached via an attachment means 68. The attachment means may be fixed, like a rivet or a nail, or it may be removable such as a screw. The weed guard 66 is positioned in front of the fixed lower hook 64 so that aquatic detritus is not accidentally ensnared in the hook. FIG. 7 also illustrates a fixed rear hook 62. The fixed rear hook 62 is positioned so that it also will not ensnare aquatic detritus. While FIG. 7 shows the weed guard 66 attached to a single wing structure, the weed guard 66 may also be applied to a bi-wing dragonfly lure, or any other combination or configuration of the present invention.

It is understood that the invention is not confined to the particular construction and arrangements and parts herein illustrated and described, but embraces such modified forms thereof as come within the scope of the following claims.

I claim:

1. A fishing lure comprising:
a. a body having a longitudinal axis extending from a first end to a second end, wherein the body includes a dorsal side and a ventral side;
b. an H-shaped wing structure including a crossbar and two sets of generally parallel extensions, wherein each set of extensions includes a distal end and proximal end, wherein the proximal ends combine at the crossbar, wherein the crossbar is positioned over and removably attached to the dorsal side of the body and the distal end of each set of extensions extends outwardly from the crossbar and perpendicularly to the longitudinal axis, wherein a space is defined between each set of extensions; and
c. an eyelet positioned on the first end of the body, the eyelet having an appropriate aperture for receiving a fishing line.

2. The fishing lure of claim 1, wherein the body is constructed of a floatable material.

3. The fishing lure of claim 1, further comprising at least one hook variably positioned and attached along the body, the one hook being suitable for ensnaring a biting fish.

4. The fishing lure of claim 1, wherein the body includes a shape resembling a dragonfly of the order Odonata and infraorder Anisoptera, such that the body comprises the first end, then a thorax portion, then a petiole portion, then an abdomen portion, and then the second end; wherein the H-shaped wing structure is structured to resemble the wings of a dragonfly.

5. The fishing lure of claim 4, wherein the crossbar of the wing structure is attached to the dorsal side at the thorax portion.

6. The fishing lure of claim 4, wherein the crossbar of the wing structure is attached to the dorsal side at the petiole portion.

7. The fishing lure of claim 1, wherein the wing structure is permanently attached to the body.

8. The fishing lure of claim 3, wherein the at least one hook is positioned and attached to the dorsal side of the body.

9. The fishing lure of claim 3, wherein the at least one hook further comprises at least one weed guard.

10. The fishing lure of claim 1, wherein the H-shaped wing structure comprises a first and a second wing structure positioned in alignment with respect to each other, wherein each wing structure includes a crossbar and two sets of generally parallel extensions, wherein each set of extensions includes a distal end and proximal end, wherein the proximal ends combine at the crossbar, wherein the crossbar of the first wing structure is positioned over and removably attached to the dorsal side of the body and the crossbar of the second wing structure is positioned in direct alignment over the crossbar of the first wing structure and removably attached to the dorsal side of the body, wherein a spacer is provided between the crossbars of the first and second wing structure such the an air space is provided between the first and second wing structures.

11. A fishing lure comprising:
a. a body having a longitudinal axis extending from first end to a second end, wherein the longitudinal axis includes a dorsal side and a ventral side;
b. a bi-wing H-shaped wing structure comprising a first and a second wing structure positioned in alignment with respect to each other, wherein each of the first and second wing structures includes a crossbar and two sets of generally parallel extensions, wherein each set of extensions includes a distal end and proximal end, wherein the proximal ends combine at the crossbar, wherein the crossbar of the first wing structure is positioned over and removably attached to the dorsal side of the body and the crossbar of the second wing structure is positioned in direct alignment over the crossbar of the first wing structure and removably attached to the dorsal side of the body, wherein a spacer is provided between the crossbars of the first and second wing structure such the an air space is provided between the first and second wing structures;
c. an eyelet positioned on the first end of the body, the eyelet having an appropriate aperture for receiving a fishing line; and
d. at least one hook positioned and attached to the dorsal side of the body.

12. The fishing lure of claim 11, wherein the body is constructed of a floatable material.

13. The fishing lure of claim 12, wherein the floatable material is selected from the group consisting of wood, plastic, metal, and foam.

14. The fishing lure of claim 11, wherein the body includes a shape resembling a dragonfly of the order Odonata and infraorder Anisoptera, such that the body comprises the first end, then a thorax portion, then a petiole portion, then an abdomen portion, and then the second end; wherein the H-shaped wing structure is structures to resemble the wings of a dragonfly, and wherein the crossbar of the wing structure is attached to the dorsal side at the thorax portion.

15. The fishing lure of claim 11, wherein the at least one hook further comprises at least one weed guard.

16. The fishing lure of claim 11, wherein the body is solid.

17. The fishing lure of claim 11, wherein the body is hollow.

18. The fishing lure of claim 11, wherein the at least one hook is positioned and attached to the bottom side of the body.
